(19) United States
(12) Patent Application Publication
(10) Pub. No.: US 2011/0252651 A1
(43) Pub. Date: Oct. 20, 2011

(54) COMBINATION BONE SAW GUIDE AND STOP AND GUTTING KNIFE STOP PADDLE

(76) Inventor: John Sewell, Chico, CA (US)

(21) Appl. No.: 12/764,081

(22) Filed: Apr. 20, 2010

(51) Int. Cl. A22B 5/16; B26B 29/02

(52) U.S. Cl. 30/289; 30/321

(57) ABSTRACT

A handgrip handle connects to an elongated protective paddle blade with an elongated trough along the length of the paddle blade and an end stop at each end of the trough. The trough receives a gutting blade when gutting a game animal to prevent puncturing the organs. The trough alternately receives a pelvic bone cutting saw when sawing the pelvic bone for removing game animal internal organs to guide the saw blade and prevent puncturing the organs. The handle may be pivotally attached to the paddle blade. A pivotable gut blade may be attached to the pivotable handle.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to a device used in field dressing game animals and particularly to a protective paddle for assisting in the field dressing of a large game animal such as deer or elk whereby the internal organs are protected alternately from a pelvic saw blade and a gutting blade thereby preventing leakage of the internal organs onto the meat.

2. Description of Related Art Including Information Disclosed Under 37 CFR 1.97 and 1.98

Many hunters use straight-bladed knives in the large game field dressing process. However, these knives are not configured for the types of cuts required, and require great skill on the part of the hunter to quickly and cleanly dress an animal. Furthermore, conventional knives—even hunter's knives and sportsmen's knives—have relatively long, thin blades which might cut into the internal organs and cause them to drain into the meat of the animal. Sawing the pelvic bone to remove the colon and bladder can also result in the saw piercing the colon, bladder or other organs causing leakage on the meat. Prior art devices have not adequately solved these problems with a single device having combined features to enable use as a colon and bladder protecting saw guide and saw stop paddle and a gut protecting paddle used in conjunction with a gut hook.

U.S. Pat. No. 7,217,182, issued May 15, 2007 to McConnell et al, is for a deer eviscerating protective tool for assisting in field dressing a deer, the tool having a protective shield of a convenient width and contour to be slid thru an incision made thru the belly skin of a deer just forward of the pelvic crest and hence into and thru the pelvic cavity between the inner surface of the crest and the colon, whereby the crest can then be sawed thru longitudinally along the crest without danger of the saw cutting into the colon or adjacent viscera and releasing meat damaging fluids.

U.S. Pat. No. 7,198,562, issued Apr. 3, 2007 to Whetstone et al, provides an animal dressing tool with a bladed lever for cutting through or splitting animal bones having a head, a handle and a knife with the head having two sides with a row of teeth at the bottom of each side to grip the bone to be cut or split and the knife having a blade positioned below and between the two sides of the head at a distance to permit the bone to be split to fit between the teeth of the head and the blade of the knife.

U.S. Pat. No. 5,690,548, issued Nov. 25, 1997 to Jones et al, shows a pelvic girdle splitter tool and method. The pelvic bone splitter has a shaft with a slot and a knurled surface on its free end. A first end of a blade is pivotally retained in the slot by a pivot pin. Cutting edges on the blade are movable into the slot. During use, a free end of the shaft is passed under the pelvic girdle and out through an aperture in the hide. Pressure is applied to the hand grip to move the cutting edge toward the slot, compress the pelvic girdle between the cutting edge and the anvil surfaces and split the pelvic girdle.

U.S. Pat. No. 5,320,576, issued Jun. 14, 1994 to Sagen, shows a one-person-powered handsaw constructed precisely to sever the pelvis bone of a deer species while providing protection against puncturing the large intestine when field-dressing the animal.

U.S. Pat. No. 5,453,043, issued Sep. 26, 1995 to Monson, describes a pelvic splitter device and method of use thereof used primarily by hunters to split the pelvis of a large game animal during the gutting and cleaning of the animal. The pelvic splitter device comprises a shaft having a hook member and a knife edge at one end thereof and further comprises an impact and handle means having two longitudinal half bodies having mirrored sides with grooves, longitudinal recesses, and recessed portions therein to receive the shaft. The impact and handle means slides upon the shaft and functions, in addition to storing the shaft when not in use, as a slide hammer to impact the rearward end of the shaft to urge the hook member and knife edge through and split the pelvis of the game animal such as a deer.

U.S. Pat. No. 4,682,417, issued Jul. 28, 1987 to Henslin et al, discloses a carcass bone splitting tool having a rod-like shank being bent over at one end to form a handle. A foot member is connected at the other end of the rod-like shaft which is shaped to prevent rupture of entrails when the carcass is being opened. An elongate cutting blade member is mounted on the rod-like shank adjacent the foot member and is used for splitting open the bone of the carcass. A striker bar is also provided to drive the blade through the bone, such as the pelvic bone and breastbone, of the dead animal. The tool described herein is portable and when not in use, the blade is protected by the striker bar which can be carried by the splitting tool.

U.S. Pat. No. 5,462,479, issued Oct. 31, 1995 to Hajek, indicates a wild game dressing tool that is light in weight and small in size, comprising two handles connected by a saw blade for field dressing a deer or the like: the tool offers a quick, safe, and easy way to split an animal's pelvic bone, allowing better cleaning of the anal area and thereby resulting in more consistent, high quality meat.

U.S. Pat. No. 3,583,024, issued Jun. 8, 1971 to Garza, puts forth a deer pelvis bone shearing knife which comprises a leverage handle and jaws which encircle the pelvis bone which is sheared when the handle is pulled down.

U.S. Pat. No. 6,280,312, issued Aug. 28, 2001 to Elrod et al, concerns a pelvic bone splitting tool which provides a number of features to assist a hunter in field dressing game, such as deer. The tool or splitter may include a lower or grip handle formed as a unitary piece with an upper jaw. The grip handle includes finger-receiving indentations, and the upper jaw may include a cutting blade. The tool may further include an upper or palm handle formed as a unitary piece with a lower jaw, and the palm handle and the lower jaw may be joined together by an angled connecting piece, and the handles pivot relative to once another about a central pivot. The lower jaw includes a splitting blade, which may be removable from the tool. Alternatively, the upper handle/lower jaw combination and lower handle/upper jaw combination may be nearly mirror images of one another. These combinations are joined together at a rotating pivot which preferably forms a smoothly rotating bearing. The tool may include a saw blade articulated into the lower handle, and a combination knife blade and gut hook articulated into the upper handle. Further, the handle/jaw elements may themselves be articulated to provide a minimum form factor for ease of transporting the tool by a hunter.

What is needed is a device which can shield the internal organs of a game animal while field dressing the animal using the device as a stop for a knife or gut hook while using them to cut the hide along the center of the underbelly and also using the device as a saw guide and a saw stop when using the saw to cut through the pelvic bone.

### BRIEF SUMMARY OF THE INVENTION

An object of the present invention is to provide an elongated organ shield and gut shield paddle having a hand grip handle and an elongated protective paddle blade with an elongated trough along the length of the paddle blade and an end stop at each end of the trough to receive a gutting blade in the trough during gutting and to receive a bone cutting saw in the trough while sawing the pelvic bone to prevent the gutting blade from piercing the guts and to guide the pelvic bone saw and stop the sawing blade from piercing the internal organs, particularly the colon or bladder, of the game animal while field dressing the animal.

In brief, the present invention comprises a colon and bladder shielding and gut shielding paddle having a trough with a stop at each end along the length of the paddle blade. The paddle handle may be rigidly attached to the paddle blade in linear alignment therewith or pivotally attached to the paddle blade with a built-in gutting blade fitting pivotally in the paddle handle. The pelvic bone saw preferably has a double bone sawing blade with two blades spaced apart in parallel alignment to cut away a larger section of pelvic bone to allow removal of the colon and bladder without puncturing them.

The present invention prevents slicing open the organs and guts inside the game animal so the organs and guts can be removed whole.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the organ shielding and gut shielding paddle of the present invention;

FIG. 2 is a perspective view of the organ shielding and gut shielding paddle of the present invention used in conjunction with a hunting knife with the handle of the hunting knife held against the paddle handle and the blade of the hunting knife angled into the trough for use as a gutting blade;

FIG. 3 is a perspective view of an alternate embodiment of the organ shielding and gut shielding paddle of the present invention having a pivotable paddle handle and a gutting blade pivotally fit in the handle showing the paddle handle pivoted at an angle to the paddle blade and the built-in gutting blade angled into the trough for use;

FIG. 4 is a perspective view of the alternate embodiment of the organ shielding and gut shielding paddle of FIG. 3 showing the gutting blade pivoted into the paddle handle and showing the paddle handle pivoted into the trough for storage;

FIG. 5 is a perspective view of the organ shielding and gut shielding paddle of the present invention used in conjunction with a double bladed pelvic bone saw with the double bone sawing blades angled into the trough.

### DETAILED DESCRIPTION OF THE INVENTION

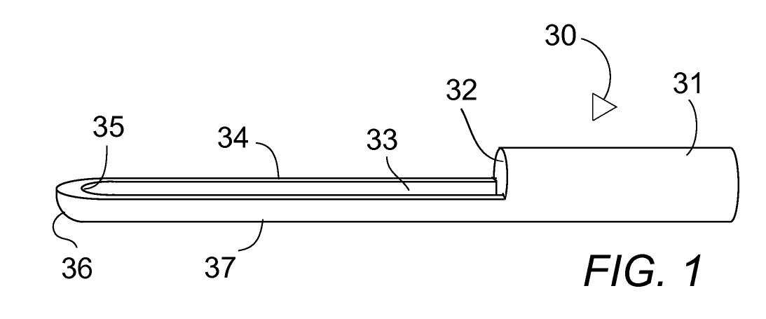

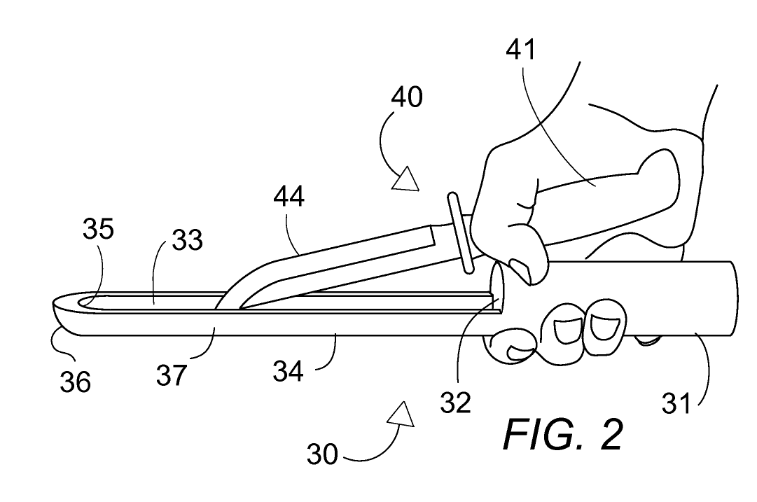

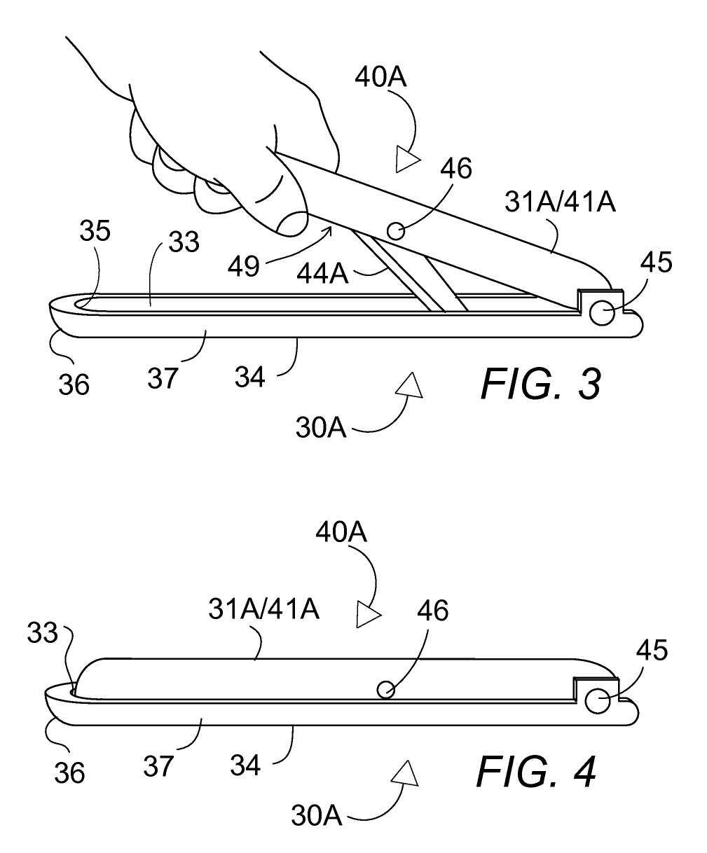

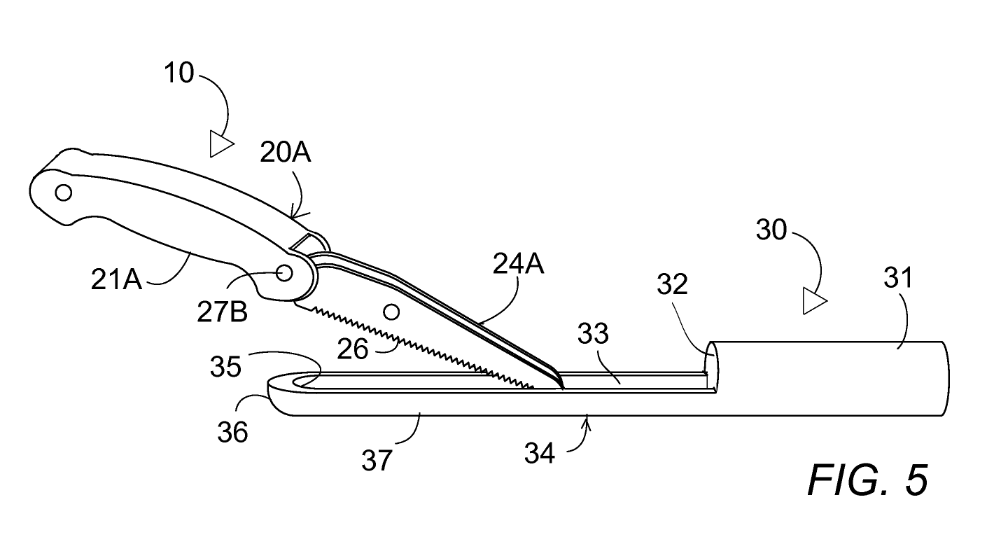

In FIGS. 1-5, an internal organ and gut shielding paddle device 30 is used in field dressing game animals in conjunction with a gutting blade, which may be a hunting knife blade 44, as shown in FIG. 2, or a built-in gutting blade 44A, as shown in FIG. 3, and alternately in conjunction with a pelvic bone sawing blade, preferably a double blade bone sawing blade 24A, as shown in FIG. 4 to guide the bone sawing blade and prevent the bone sawing blade from puncturing the colon or bladder. The device comprises a paddle blade 34 and a paddle handle 31, as shown in FIGS. 1, 2, and 4, which may, in another embodiment, be a combined pivoting paddle handle and built-in pivoting gutting blade 31A/41A, as shown in FIG. 3.

The elongated paddle blade 34 attached to the paddle handle 31 and 31A/41A has a convexly curved point 36 on an outer end and an elongated bottom 37 having a transverse convexly curved bottom along the length of the paddle blade to provide a smooth surface for ease of insertion of the paddle blade under the pelvic bone of the game animal when used with a pelvic bone saw and ease of insertion of the paddle blade under the hide of the game animal when used with a gutting blade. The paddle blade has an elongated trough 33 having semi-circular transverse concave section extending into a top surface of the paddle blade along the length of the paddle blade. The paddle blade further comprises an outer end blade stop 35 at an outer end of the trough and an inner end blade stop 32 at an intersection of the paddle blade and the paddle handle.

In a first usage in conjunction with a pelvic bone saw 10, as shown in FIG. 4, during a field dressing of a game animal, the paddle blade 34 is a pelvic bone saw guide and an internal organ shield inserted under the pelvic bone to receive the pelvic bone saw blade 24A in the trough 33 guiding the pelvic bone saw blade and shielding the internal organs from the pelvic bone sawing blade sawing through the pelvic bone.

In a second usage with a gutting blade 44 and 44A contacting the trough during the field dressing of the game animal, as shown in FIGS. 2 and 3, the paddle blade 34 is a gut shield inserted under the animal hide moving with the gutting blade 44 and 44A, the paddle blade 34 shielding the guts as the gutting blade 44 and 44A cuts open the hide.

In FIG. 2, the gutting blade 44 comprises a knife blade, wherein a knife blade handle 41 is held against the paddle handle 31 and the knife blade 44 is angled into the trough 33 with the knife blade edge facing the outer curved end 36 of the paddle blade.

In FIG. 3, a combined built-in gutting blade and pivotable paddle handle 31A/41A comprises a built-in gutting blade 44A attached by a pivot 46 to the paddle handle 31A/41A and the paddle handle has a slot 49 along the length of the paddle handle so that the built-in gutting blade 44A pivots into the paddle handle for storage and further comprising a pivot 45 between the paddle blade 34 and the paddle handle 31A/41A so that the paddle handle pivots outward for use, as shown in FIG. 3, having the paddle handle 31A/41A in an angular orientation to the paddle blade 34, having the built-in gutting blade 44A opened out at an angle to the paddle handle 31A/41A having a point of the built-in gutting blade 44A contacting the trough 33, and having a cutting edge of the built-in gutting blade facing the outer rounded end 36 of the paddle blade so that movement of the device with the paddle blade under the hide of the game animal causes the gutting blade to cut open the hide for gutting while the paddle blade prevents the built-in gutting blade from puncturing the internal organs. The paddle handle 31A/41A is configured to fit within the trough 33 so that the pivot handle alternately pivots into the trough for storage, as shown in FIG. 4.

In FIG. 5, the internal organ and gut shielding paddle device 30 is used in conjunction with a double blade pelvic bone sawing device 10 wherein the semi-circular trough 33 receives the pair of bone sawing blades 24A within the trough to guide and restrict the movement of the bone sawing blades therein to prevent the pair of bone sawing blades from puncturing the internal organs when sawing through the pelvic bone, particularly protecting the bladder.

In use, the internal organ and gut shielding paddle device 30 is used in field dressing game animals in conjunction with a gutting blade 44 and 44A to shield the guts of the game animal from the gutting blade while gutting the game animal to allow removal of the guts of the game animal without puncturing the guts and also used in conjunction with a pelvic bone sawing blade 24A to guide the pelvic bone sawing blade and to shield the colon, bladder and other organs while sawing through the pelvic bone to allow removal of the organs from the game animal without puncturing the organs and provide a larger opening with the double blade pelvic bone saw for ease of cleaning the pelvic cavity.

It is understood that the preceding description is given merely by way of illustration and not in limitation of the invention and that various modifications may be made thereto without departing from the spirit of the invention as claimed.

What is claimed is:

1. An internal organ and gut shielding paddle device for use in field dressing game animals, the device comprising:
a paddle handle providing a handgrip for a user;
an elongated paddle blade attached to the paddle handle, the paddle blade having a convexly curved point on an outer end and an elongated bottom having a transverse convexly curved bottom along the length of the paddle blade to provide a smooth surface for ease of insertion of the paddle blade under the pelvic bone of the game animal when used with a pelvic bone saw and ease of insertion of the paddle blade under the hide of the game animal when used with a gutting blade; the paddle blade having an elongated trough having semi-circular transverse concave section extending into a top surface of the paddle blade along the length of the paddle blade; an outer end blade stop at an outer end of the trough; and an inner end blade stop at an intersection of the paddle blade and the paddle handle; so that in a first usage in conjunction with a pelvic bone saw during a field dressing of a game animal, the paddle blade is an internal organ shield inserted under the pelvic bone to receive the pelvic bone saw in the trough to guide the pelvic bone saw and to shield the internal organs from the pelvic bone sawing blade sawing through the pelvic bone, and so that in a second usage with a gutting blade contacting the trough during the field dressing of the game animal, the paddle blade is a gut shield inserted under the animal hide moving with the gutting blade, the paddle blade shielding the guts as the gutting blade cuts open the hide; thereby providing a combination internal organ and gut shielding paddle device for use in field dressing game animals.

2. The device of claim 1 wherein the gutting blade comprises a knife blade wherein a handle of the knife blade is held against the paddle handle, the knife blade angled into the trough with the knife blade edge facing the outer end of the paddle blade.

3. The device of claim 1 further comprising a pivot between the paddle blade and the paddle handle so that the handle pivots out at an angle to the paddle blade in a first position for use and the paddle handle is configured to fit within the trough so that the pivot handle alternately pivots into the trough for storage.

4. The device of claim 3 further comprising a built-in gutting blade attached by a pivot to the paddle handle and the paddle handle has a slot along the length of the paddle handle so that the built-in gutting blade pivots into the paddle handle for storage and alternately the built-in gutting blade pivots outward for use having the paddle handle in an angular orientation to the paddle blade, having a point of the built-in gutting blade contacting the trough, and having a cutting edge of the built-in gutting blade facing the outer end of the paddle blade so that movement of the device with the paddle blade under the hide of the game animal causes the gutting blade to cut open the hide for gutting while the paddle blade prevents the built-in gutting blade from puncturing the internal organs.
